(19) United States
(12) Patent Application Publication
(10) Pub. No.: US 2007/0120017 A1
(43) Pub. Date: May 31, 2007

(54) APPARATUS AND ASSOCIATED METHOD FOR FACILITATING AERIAL PHOTOGRAPHY

(75) Inventors: Jadon Ray Webb, Dallas, TX (US); Ramsey Stone, Dallas, TX (US)

Correspondence Address: SCHEEF & STONE, L.L.P., 5956 SHERRY LANE, SUITE 1400, DALLAS, TX, 75225, US

(73) Assignee: FONCANNON, INC., Dallas, TX (US)

(21) Appl. No.: 11/538,234

(22) Filed: Oct. 3, 2006

Related U.S. Application Data
(60) Provisional application No. 60/723,509, filed on Oct. 4, 2005.

(51) Int. Cl. B64C 31/06

(52) U.S. Cl. 244/153 R

(57) ABSTRACT

In an apparatus for facilitating aerial photography, a camera is secured to a three-dimensional geometric kite in a position that is substantially fixed relative to the kite. The camera is configured for taking aerial photographs while said kite is in flight.

### CROSS-REFERENCE TO RELATED APPLICATION

This application claims the benefit of U.S. Provisional Patent Application No. 60/723,509, filed Oct. 4, 2005, which application is hereby incorporated herein by reference in its entirety.

### TECHNICAL FIELD

The invention relates generally to aerial photography and, more particularly, to a method and system of facilitating aerial photography by utilizing a camera secured onto, within, or proximate to a box kite, or a cellular element of a box kite.

### BACKGROUND

For nearly as long as there have been cameras, people have devised different methods and systems of attaching camera payloads to kites, and the sport of kite aerial photography, which involves taking photographs from a camera secured in some manner to a kite, has been increasing in popularity. Virtually all conventional methods and systems of securing a camera to a kite involve the use of several strings or cables running from the kite body or kite line down to a cradle which holds the camera. For example, U.S. Pat. No. 578,980 granted in 1897 to Eddy discloses such a method of securing a camera to a kite via strings. A similar method is employed in U.S. Pat. No. 1,313,564 granted in 1919 to Todd. The attachment strings are typically arranged in such a way as to provide stability to the camera so that clear photographs can be taken. U.S. Pat. No. 1,528,933 granted in 1922 to Lyon discloses a camera suspended by pivoting joints attached to a specialized fuselage under a surveillance kite.

The conventional methods of attaching a camera to a kite are typically not only relatively costly, but also complex, requiring a fair amount of mechanical ability in order to correctly set up and operate. The setup and assembly process often exceeds not only an individual's budget, but also the technical reach of many people, and/or the time that many people have to devote to such endeavors.

A further shortcoming associated with conventional kite aerial photography methods and systems is that the kite, camera, and accessories to secure the camera to the kite must be obtained separately, which is inconvenient and time-consuming. Moreover, such separate components are not designed to readily fit and work together, and instead typically require that one or more of the separate parts be substantially modified to fit and work together in the final kite aerial photography assembly. This process of fitting and shaping separate components to correctly fit and work together presents another formidable obstacle for those with limited time and/or mechanical ability.

Therefore, there is a need for a simpler, less costly, and less time-consuming method and system of taking aerial photographs from kites. Such a method and system would preferably even be embodied in a kit having substantially all components needed for taking aerial photographs from kites.

### SUMMARY

The present invention, accordingly, provides a simplified method and system of taking aerial photographs from kites by securing a camera onto or within a box kite, or one or more cellular elements of a kite. According to one preferred embodiment of the invention, a camera is secured with clips to supporting rods within a box kite in a position that is substantially fixed relative to the kite. The camera is configured for taking aerial photographs while the kite is in flight.

In a further preferred embodiment of the invention, a kite aerial photography setup is simplified by providing in a kit most or all of the components necessary for the kite aerial photography setup, such components preferably being designed to fit and work together.

There are a number of advantages to the present invention over the prior art. For example, setup is substantially easier and simpler than with the prior art. There is, for example, no need for a series of long cables to suspend the camera below the kite. Instead, in one preferred embodiment, the user quickly secures the camera to part of the box frame, such as support braces, sets a camera timer or remote control, and can then fly the kite and take pictures. Another advantage of using box kites or cellular elements is that they typically provide strong, stable flight which is desirable for minimizing blur in images taken using aerial photography. Box kites or cellular elements also typically contain convenient openings that allow a camera secured inside to be directed at different angles and to have unobstructed photographic views of the outside free from such things as kite support poles, sail material, or kite string. The process of obtaining a kite aerial photography setup is also greatly simplified herein by providing for a ready-made kit in which all of the components for the kite aerial photography setup are provided.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 exemplifies a perspective view of a camera secured to a kite in accordance with one preferred embodiment of the present invention;

FIG. 2 exemplifies a back side of a camera configured with clips adapted for being secured to cross support rods associated with the kite of FIG. 1;

FIG. 3, taken along the line 3-3 of FIG. 1, exemplifies the camera of FIG. 2 attached to cross support rods in the kite of FIG. 1;

FIG. 4 is a perspective view of one preferred embodiment of a clip;

FIG. 5 is a cross-section of the clip of FIG. 4 taken along the line 5-5 of FIG. 4;

FIGS. 6-8 illustrate a sequence of engaging the clip of FIG. 4 to a rod of the kite of FIG. 1;

FIG. 9 exemplifies an alternative embodiment of the present invention, wherein a camera is placed on cross braces centrally located on a side of a box kite;

FIG. 10 exemplifies a second alternative embodiment of the present invention, wherein a camera is placed inside of a triangular cellular element;

FIG. 11 exemplifies a third alternate embodiment of the present invention, wherein a camera is placed inside of a cylindrical element;

FIG. 12 exemplifies an embodiment of the present invention wherein wireless communications are effectuated between the camera and a user;

FIG. 13 exemplifies a kite and camera kit assembly; and

FIG. 14 exemplifies an embodiment of the present invention wherein a camera is secured to a sail of a kite.

### DETAILED DESCRIPTION

Refer now to the drawings, wherein depicted elements are, for the sake of clarity, not necessarily shown to scale, and wherein like or similar elements are designated by the same reference numeral through the several views. Additionally, for the most part, details concerning wireless communications, cameras, such as digital cameras, their operation, and the like, have been omitted inasmuch as such details are not considered necessary to obtain a complete understanding of the present invention, and are considered to be within the skills of persons of ordinary skill in the relevant art.

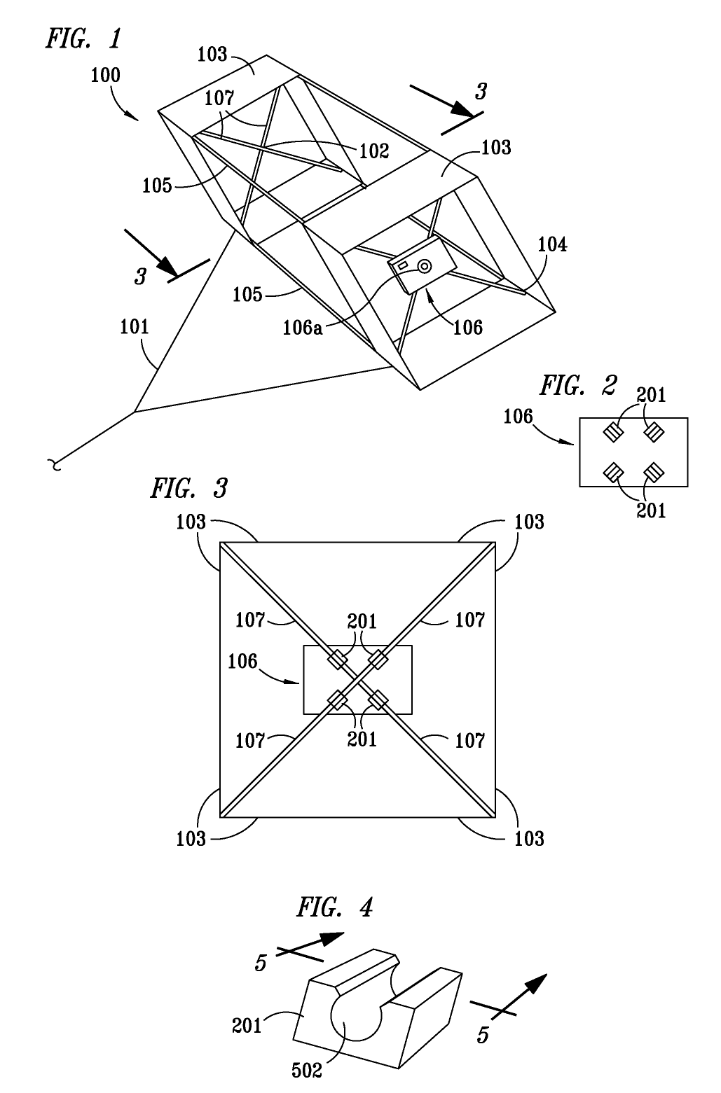

Referring to FIG. 1 of the drawings, the reference numeral 100 generally designates a kite, preferably a three-dimensional geometric kite, exemplified in FIG. 1 as a box kite, or a cellular kite, embodying features of the present invention. As described in further detail below, the kite 100 preferably comprises structural members, such as four substantially parallel, longitudinal struts, or rods, 105 secured together via two internal cross support struts 107 proximate to each end of the kite 100, and sheet, or sail, material 103. A tether 101, such as Spectra® or Kevlar® string or cord, comprises two portions attached at one end to one or more longitudinal rods 105 on the kite 100, and the other end of the tether 101 is held, and thereby restrained, by a user (not shown).

As used herein, the term “rod” refers to any kind of elongated object, such as a strut, pole, a spar, a longeron, or a beam of any dimension, and comprising any of a number of materials, such as wood, bamboo, fiberglass, metal, or the like, that is sufficiently tough, flexible, and lightweight to be suitable for use in a kite. Rods may be associated with many different types of kites as is well known to those skilled in the art. Rods typically serve as structural supports in a kite, as for example the longitudinal rods 105 and the internal cross support rods 107 depicted in FIG. 1, which rods prevent the box kite from collapsing while in flight. However, rods need not necessarily serve a structural or support function, but instead or additionally may be ornamental, or may only serve as an attachment point for other items. Rods may extend within the inside of a kite, or may protrude partially or wholly outside of the kite.

The term “box kite” as used herein, refers to any substantially non-flat kite with a three dimensional geometric shape. The most familiar shape of a box kite is a box with a square cross section, as exemplified in FIG. 1, or alternatively a rectangular cross section (not shown). However, the framework of a box kite or cellular element (defined further below) is not limited to a rectangular box shape. Box kites may comprise a variety of other geometric shapes, including triangular shapes, round shapes such as circles or ellipses, and the like. Certain box kites may alternatively have more complex geometric shapes comprising numerous straight or curved walls and edges. Box kites or cellular elements may also have various kinds of wings and flaps attached to them for modifying stability, lift, or artistic design.

The term “cellular element” as used herein refers to a box-like or other three dimensional geometric kite structure which constitutes only a portion of a kite. For instance, a large flat delta kite may contain a small triangular cellular element in the center to improve stability. Commonly, any kite containing a cellular element is referred to as a box kite, and a whole assembly may be referred to as simply a kite containing a cellular element. But regardless of nomenclature, the principles of the present invention are understood to apply to any kite structure comprising a three-dimensional element constituting either a part or the whole of a kite.

The longitudinal rods 105 typically provide the open framework for the box kite 100. The sail material 103 preferably comprises ribbons of relatively tough, flexible sheet material, such as nylon, polyester, Dacron®, silk, linen, hemp, or the like, and is typically wrapped around the longitudinal rods 105 at each end of the kite 100 to create lift under wind conditions. It is understood that the quantity and placement of the sail material 103 may vary with different box kites or cellular element designs as would be apparent to any skilled artisan. The internal cross support rods 107 keep the structure open and prevent collapse during flight, although, as is well known in the art, certain box kites or cellular elements may be constructed in such a way that the internal cross support rods 107 are not necessary. In a preferred embodiment, internal cross support rods 107 are secured (e.g., by adhesive, solder, tack welds, mechanical fasteners, or the like) to the longitudinal rods 105 within the kite at points 104. The internal cross support rods 107 cross in the interior of the kite 100 at a point designated by the reference numeral 102.

FIG. 2 exemplifies a back side (i.e., opposite the side of a lens 106a, FIG. 1) of a camera 106, configured in accordance with principles of one preferred embodiment of the invention, with fasteners, such as clips 201, described in further detail below, adapted and positioned for being secured to the internal cross support rods 107. The camera 106 may comprise any of a number of different cameras. For example, in one preferred embodiment, the camera 106 may comprise a digital still camera of any suitable size or shape, preferably relatively small and lightweight, and preferably having an internal or external timer that facilitates the taking of a series of temporally spaced-apart photographs while the camera is in flight. Alternatively, the camera 106 may be configured to respond to commands given remotely by a user from the ground, such as wireless commands transmitted via radio frequency (RF) signals or infra red (IR) signals. The camera 106 may alternatively be operative via film, or may comprise a video camera. The clips 201 are preferably permanently secured to the back side of the camera 106 using any of a number of different techniques, such as adhesive, mechanical fasteners, or the like, or the clips 201 may be secured to straps (not shown) attached to the camera 106, or to a case (not shown) that at least partially envelops the camera 106, to thereby secure the clips permanently or temporarily to the camera 106 as desired.

FIG. 3, taken along the line 3-3 of FIG. 1, depicts the camera 106 attached via the clips 201 to the cross support rods 107 of the kite 100. The clips 201 preferably engage the rods 107 so that the lens 106a (FIG. 1) of the camera 106 faces outwardly, away from the kite 100, to thereby provide a desirable position from which to take aerial photographs of the ground and/or of the horizon, as discussed in further detail below.

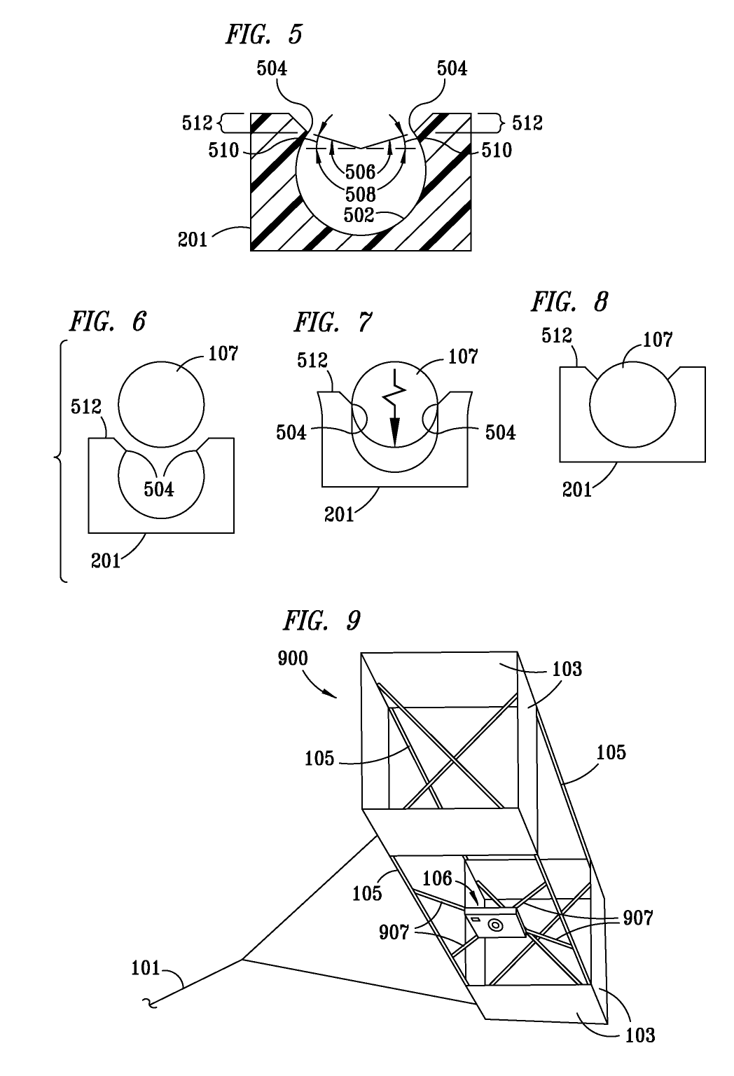

FIG. 4 shows a perspective view of one preferred embodiment of the clip 201, and FIG. 5 shows a top view of the clip 201 taken along the line 5-5 of FIG. 4. As shown, the clip 201 defines a hollow interior portion 502 extending longitudinally through the clip 201, and partially cylindrically through an arc 506 comprising an arc 508 of 180° and two arcs 510 in the range of about 5° to about 30°, and preferably about 10° to about 15°. Lips 504 are defined at the ends of the 180° arc 508. Funnellers 512 preferably extend from the lips 504 for funneling the rod 107 into the hollow interior portion 502 of the clip 201, and for operating to open the lips 504 to there facilitate receiving of the rod 107 into the clip 201, as discussed below with respect to FIGS. 6-8. The diameter of the interior portion 502 is preferably sized to receive the rod 107. The clip 201 is preferably fabricated from a strong, but pliable material, such as metal or hard plastic, effective for enabling the lips 504 and the hollow interior portion 502 to open when the clips 201 are applied to the rods 107, and to return to their original position once the clip 201 has received the rod 107 to secure the rod thereto.

In operation, the camera 106 is attached to the kite 100 (FIGS. 1 and 3) by securing the clips 201 to the rods 107, as exemplified with one clip in FIGS. 6-8. More specifically, in FIG. 6, a user (not shown) moves the rod 107 and the clip 201 toward each other. In FIG. 7, the user applies downward (as viewed in FIG. 7) force onto the rod 107 (and/or upward force on the clip 201) so that the rod 107 and the clip 201 engage each other and, the rod 107 acts as a wedge on the funnellers 512 to temporarily deform and open the lips 504 of the clip 201. As shown in FIG. 8, with continued force, the hollow interior portion 502 of the clip 201 receives the rod 107 and the lips 504 close upon the rod 107 to secure the rod therein. The steps depicted by FIGS. 6-8 are repeated for each of the four clips 201 and respective rod 107. The camera 106 is then suitably set to automatically take pictures at predetermined points in time, such once every 10 seconds, once every minute, once every 5 minutes, or the like. The kite 100 is then flown in a conventional manner for a sufficient time to allow the camera 106 to take a desirable number of pictures pursuant to the settings on the camera 106. Upon completion of flying of the kite 100, the camera 106 is removed from the kite by removing the clips 201 from the rods 107 wherein the steps exemplified by FIGS. 6-8 are essentially reversed with the application to the rod 107 of an upward (as viewed in FIG. 5) force. Pictures are then retrieved from the camera 106 in a conventional manner.

In alternative embodiments of the invention, the camera 106 may be secured to the rods 107 located in a number of different locations on or within the kite 100. For example, FIG. 9 depicts a kite 900, similar to the kite 100, having cross support rods 907, similar to the internal cross support rods 107, that are attached to a substantially central position of the longitudinal rods 105, and the camera 106 is secured to the rods 907 via the clips 201, as discussed above. Operation of the kite 900 and camera 107 is similar to that described above with respect to FIGS. 1-8. An advantage of the embodiment of FIG. 9 is a low polar moment of inertia relative to the embodiment of FIGS. 108.

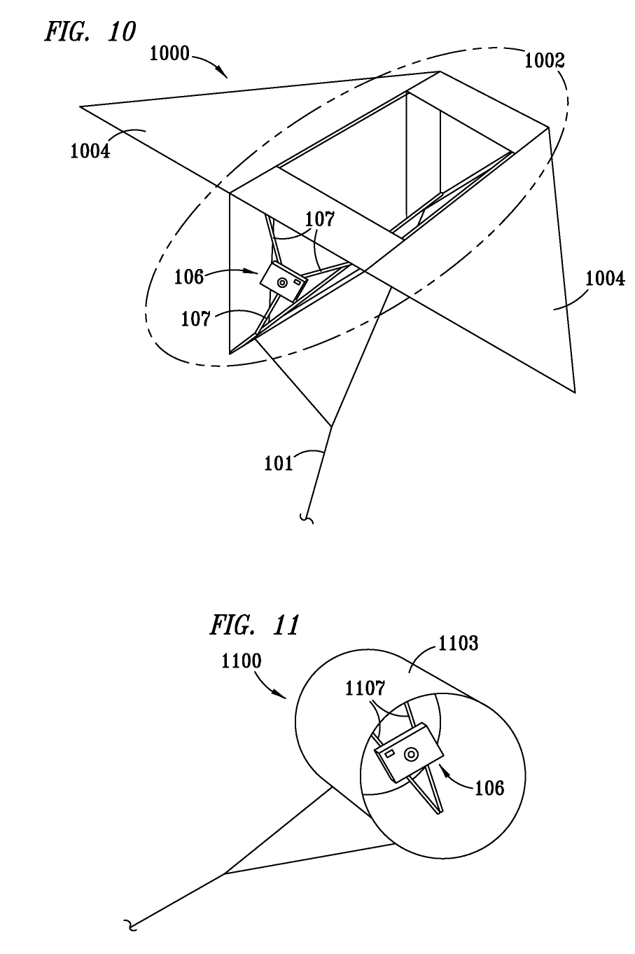

In further alternative embodiments of the invention, the kite 100 may be configured as any of a number of different three-dimensional geometric shapes, or may comprise a number of cellular elements having any number of three-dimensional geometric shapes. For example, in FIG. 10, a kite 1000, commonly referred to as a delta-box kite, is configured having a triangular shaped cellular element 1002, with wings 1004 extending outwardly to enhance the stability and lift of the kite 1000. A camera 106 is preferably attached to rods 107 extending inwardly within the kite 1000 in a manner similar to that described above with respect to FIG. 1. Operation of the kite 1000 is similar to the operation of the kite 100 described above with respect to FIGS. 1-9.

In a further example, a kite may be configured having round or curved geometrical shapes, such as an elliptical shape, or as depicted in FIG. 11, a cylindrical shaped kite 1100. In the kite 1100, a camera 106 is preferably positioned within the kite and secured there via wires 1107 attached directly to sail material 1103. Operation of the kite 1100 is similar to the operation of the kite 100 described above with respect to FIGS. 1-8.

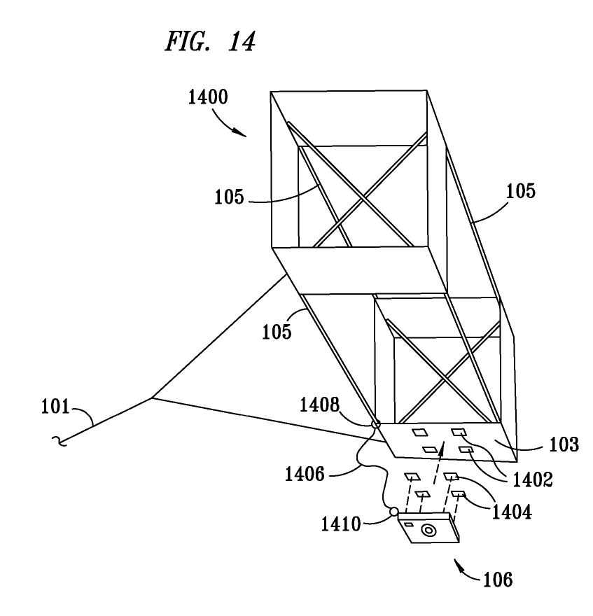

In still further alternative embodiments of the invention, the camera 106 may be sufficiently lightweight to permit attachment of the camera directly to the sail material 103, rather than the rods 107, of the kite 100, to thereby reduce drag on the kite. By way of example but not limitation, the camera 106 may be positioned within a small pouch sewn into the sail material 103, the camera may be sewn directly to the sail material 103, or the camera may be attached to the sail via straps, an adhesive, or a hook-and-loop material, such as Velcro . As exemplified in FIG. 14, in a kite system 1400, a camera 106 is preferably secured via Velcro® hook 1402 and loop 1404 (or hook 1404 and loop 1402) to a sail 103. A tether 1406 is preferably connected between a point 1408 on the kite to a point 1410 on the camera 106 to retain the camera to the kite in case the means (e.g., Velcro®) for securing the camera to the kite fails. Operation of the kite system 1400 is substantially similar to the operation of the kites described above with respect to FIGS. 1-11.

In alternative embodiments, rather than securing the camera to rods 107 or 907 or sail material 103, the camera 106 may be secured to strings, wires, web meshing, strips of kite material, poles, or other materials located at various places on, within, or proximate to the kite 100. If the camera 106 is sufficiently lightweight, multiple cameras 106 may be secured to the kite 100 utilizing any of the techniques described herein. If a camera is positioned on one end of a kite, a counter weight equal to the weight of the camera may be positioned on an opposing end of the kite to balance the kite. Operation of such kites is similar to the operation of the kites described above with respect to FIGS. 1-11.

In still further alternative embodiments, the present invention may utilize a kite comprising any number of cellular elements, such as the triangular element 1002 (FIG. 10). The kite may also utilize wings and/or flaps, aesthetic patterns and/or designs formed on the body or material of the kite, combined to form any of a number of different and more complex kite designs, artistic designs, and/or to impart particular flight characteristics (e.g., stability and lift) to a kite. The camera 106 may be coupled to the kite, for example, via wires or rods 107 or sail material 103, positioned on or within any of the cellular elements of such a kite. Certain box kites may optionally include two or more separate cellular elements that are spaced apart from each other using, for example, string, poles, sail material, and the like. A double-box delta kite, well-known in the art, is such an example, in which two cellular elements are laterally separated by a substantially flat kite surface between them. A camera may optionally be secured to materials proximate to, or between, two or more cellular elements, such as to a flat portion between two cellular elements of a double box delta kite. Operation of such kites is similar to the operation of the kites described above with respect to FIGS. 1-11.

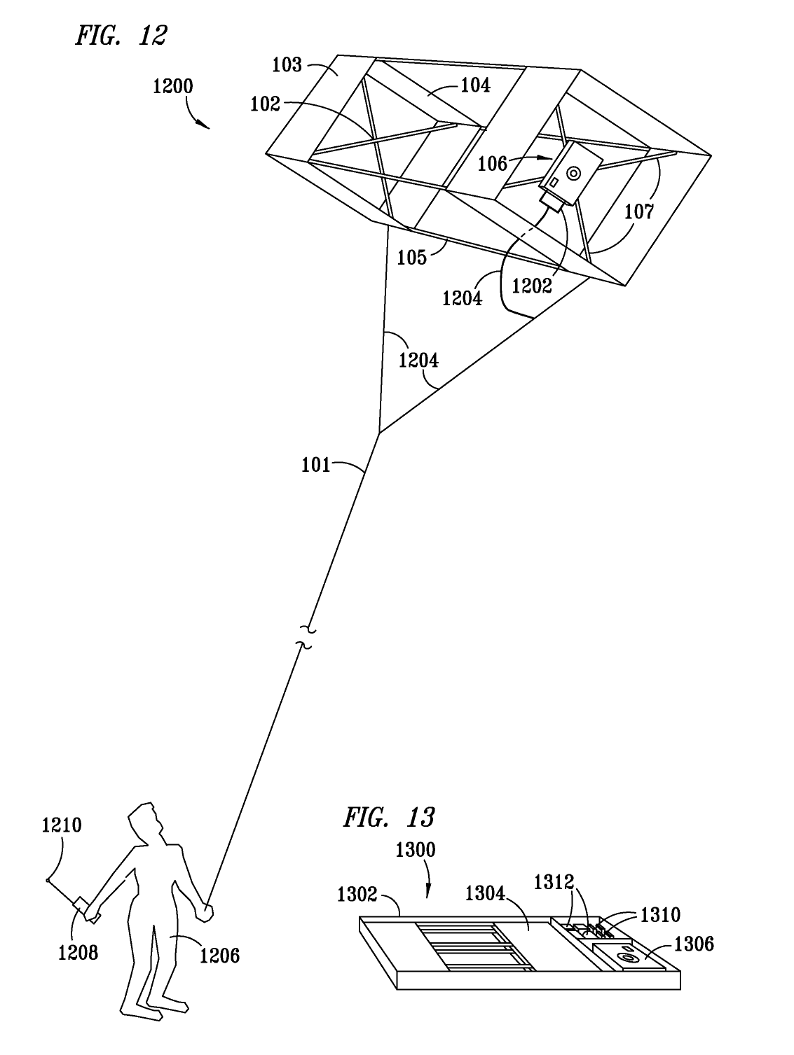

FIG. 12 depicts a further alternative preferred embodiment of the present invention, wherein two-way wireless communication is implemented between the camera 106 and a communication device operative at ground level to preferably facilitate remote control and monitoring of the camera by a user on the ground. As shown in FIG. 12, a system 1200 comprises an embodiment of a kite and camera 106 similar to the embodiment of FIG. 1, but for also including a wireless communication device 1202 coupled to the camera 106. It is understood that the kite and camera configuration of FIG. 12 may alternatively comprise any of the configurations described above. The device 1202 is preferably coupled to a wire antenna 1204 to which the string 101 is attached and restrained at an opposite end thereof by a user 1206. A ground level communication device 1208, effective for wireless communication with the aerial communication device 1202, is depicted in FIG. 12 as being held by the user 1206, though it could be positioned at any location proximate to the user, such as on a table. The ground level communication device 1208 includes an antenna 1210 and preferably comprises a handheld LCD screen, such as on a cell phone or a Gameboy® device, but may comprise any electronic processor device effective for wireless communications, such as a laptop computer, or the like. The wireless communication medium is preferably radio frequency (RF), though infra red (IR) may alternatively be used. In a first embodiment of the system 1200, the ground level communication device 1208 is preferably configured for transmitting signals, via the antennas 1204 and 1210, to the aerial communication device 1202 to indicate when a picture should be taken. Upon receipt of such signal, the device 1202 actuates the camera 106 to take a picture. It is considered that the actuation of the camera by a device such as the aerial communication device 106 (using e.g., actuators such as servos) would be apparent to a person skilled in the art upon a reading of the present disclosure, and therefore is not described in further detail herein. In a second embodiment of the system 1200, the camera preferably generates images (e.g., still or video images, optionally at a lower resolution than the image that would be recorded by the camera 106) to the aerial communication device 1202, which device 1202 then transmits the images, via the antennas 1204 and 1210, to the ground communication device 1208, which device 1208 reproduces the image for viewing by the user 1206. In a preferred embodiment of the system 1200, both the first and second embodiments are enabled, and the system 1200 is configured for communicating relatively low-resolution images (still and/or video), and in operation, the user 1206 views images transmitted from the aerial communication device 1202 to the ground communication device 1208, and then transmits a signal, via the communication devices 1202 and 1208, back to the camera 106 when a relatively high-resolution version of the image being viewed by the user should be recorded by the camera 106. In an alternate preferred embodiment of the system 1200, both the first and second embodiments are enabled, and the system 1200 is configured for communicating relatively high-resolution images (still and/or video), and in operation, relatively high-resolution images are transmitted from the aerial communication device 1202 to the ground communication device 1208, and all or selected ones of such images are recorded by the ground communication device 1208 or a memory (not shown) coupled to the ground communication device 1208, thereby rendering unnecessary the need for memory components in the camera 106, and significantly enhancing the number of images that may be taken and recorded, while simplifying the camera 106 and memory and power demands for the camera. Operation of the system 1200 is otherwise similar to the operation of the embodiments of FIGS. 1-11.

FIG. 13 illustrates an alternative preferred embodiment of the present invention wherein substantially all components needed to needed for assembling a kite with a camera for taking aerial photographs are provided in a kit 1300. More specifically, the kit 1300 preferably includes a container 1302 into which are packaged a kite 1304, a camera 1306, and fastening means 1310 for fastening the camera 1306 to the kite 1304. The kite 1302 is depicted as a collapsed box kite, though any of any of a number of different types of kites may be included in the kit, such kites including, by way of example but not limitation, a flat kite, a delta box kite, a cellular kite, a cylindrical kite, a bowed kite, a dihedral kite, a sled kite, a cellular kite, and a parafoil kite. The camera 1306 is preferably similar to the camera 106, and as such, may embody a digital or film still camera and/or a video camera. The fasteners 1310 may include, by way of example but not limitation, at least one of the clips 201, pockets on the sail material, string, adhesive, straps, a Picavet, a pendulum, hook-and-loop material, magnets, wire and/or the like. Assembly instructions and a variety of optional accessories 1312, such as glue or the like, may be included with the kite 1304 and camera 1306. The container 1302 may comprise a box, a bag, shrink wrap, molded form-fitting plastic, and/or the like. The kite 1304 and camera 1306 components of the kit 1300 may be bundled together into one container 1302, or alternatively, the components may be sold in separate packages or modules of a set. Separate components or modular packaging would be advantageous if, for example, a user preferred to purchase or return only one of the components of the kite aerial photography assembly, or preferred to mix and match different combinations of kites 1304 and cameras 1306. Separate or modular packaging would also enable users to select varying levels of quality and cost of a kite 1304 and/or camera 1306. Kits may exclude a camera, but include a kite configured for receiving any of a number of different cameras that a user may prefer to use for aerial photography. For example, a kite may include a pouch on a sail configured for receiving a camera, or a container configured for receiving a camera and affixed to structural members of the kite. Kits may include substantially only parts and components necessary to secure a camera to a kite. The kits 1300 may come completely assembled and ready to fly, or may require some assembly, including the use of outside materials such as glue or string. Kits may also include wireline or wireless communication devices as described above with respect to FIG. 12. Operation of the embodiment of FIG. 13 would include assembly and, otherwise, would be similar as described above with respect to FIGS. 1-12.

It is understood that the present invention may take many forms and embodiments. Accordingly, several variations may be made in the foregoing without departing from the spirit or the scope of the invention. For example, rather than using clips, the camera may be secured to the kite via any fastener, adhesive, hook-and-loop material (e.g., Velcro®), magnets, or the like, and/or may be permanently attached to the rods 107 and removably attached to the camera, or the clips or fasteners or the like may be permanently attached both the kite 100 (e.g., the rods 107) and the camera 106, or could be removably attached to both the kite 100 and the camera 106. A camera may provided as a standalone product with means for securing the camera to any type of kite, such means including adhesive, Velcro®, fasteners, and the like. In another example, the camera 106 may be tethered to a kite, such as the kite 100, so that if fasteners (e.g., the clips 201) fail to secure the camera to the kite (e.g., during strong winds), then the camera will not fall to the ground, which could not only result in damage to the camera, but possibly also injury to persons and/or property and associated liability. Payloads other than a camera could also be carried up with the kite, such payloads including but not limited to paper or model airplanes or gliders, and the like. Lights may be provided for illuminating the kite during flight at night. The kite 100 and camera 106 may also be provided with vibration reduction mechanisms to stabilize and/or control the camera and what it photographs, similar to existing technology used in many camera lenses and video cameras. The tether 101 may comprise a pair of wires, and the communication described with respect to FIG. 1200 may be effectuated through the wires, rather than wirelessly.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. An apparatus for facilitating aerial photography, the apparatus comprising:
a three-dimensional geometric kite; and
means for securing a camera to said kite in a position that is substantially fixed relative to said kite, said camera being configured for taking aerial photographs while said kite is in flight.

2. The apparatus of claim 1, wherein said three-dimensional geometric kite comprises at least one of a box kite, a delta box kite, a cellular kite, and a cylindrical box kite.

3. The apparatus of claim 1, wherein said three-dimensional geometric kite comprises two or more cellular elements assembled together to form said kite.

4. The apparatus of claim 1, wherein said kite comprises one or more structural members configured to form a framework for said kite, and wherein said camera is secured to at least one of said one or more structural members.

5. The apparatus of claim 1, wherein said kite comprises one or more structural members configured to form a framework for said kite, and wherein said apparatus further comprises clips adapted for securing said camera to said one or more structural members.

6. The apparatus of claim 1, wherein said kite comprises one or more structural members configured to form a framework for said kite, sail material is wrapped around at least portions of said framework, and wherein said camera is secured to said sail material.

7. The apparatus of claim 1, wherein said kite comprises at least two spaced cellular elements, and wherein said camera is interposed between said at least two spaced cellular elements.

8. The apparatus of claim 1, further comprising a timer coupled to said camera for actuating said camera to take at least one picture after at least one predetermined lapse of time.

9. The apparatus of claim 1, further comprising an aerial communication device coupled to said camera, said aerial communication device being responsive to signals transmitted from a ground communication device for actuating said camera to take a photograph.

10. The apparatus of claim 1, further comprising an aerial communication device coupled to said camera, said aerial communication device being adapted for receiving images generated by said camera and transmitting said images to a ground communication device.

11. A method for facilitating aerial photography, the method comprising the step of securing a camera to a three-dimensional geometric kite so that said camera is in a substantially fixed position relative to said kite, said camera being configured for taking aerial photographs while said kite is in flight.

12. The method of claim 11, further comprising the step of adapting said camera to be secured to said kite.

13. The method of claim 11, further comprising the step of providing said camera with adhesive for securing said camera to said kite.

14. The method of claim 11, wherein said three-dimensional geometric kite comprises at least one of a box kite, a delta box kite, and a cylindrical kite.

15. The method of claim 11, wherein said three-dimensional geometric kite comprises one or more cellular elements assembled together to form said kite.

16. The method of claim 11, wherein said kite comprises at least two spaced cellular elements, and wherein the step of securing further comprises securing said camera between said at least two spaced cellular elements.

17. The method of claim 11, wherein said kite comprises one or more structural members configured to form a framework for said kite, and wherein said step of securing further comprises securing said camera to at least one of said one or more structural members.

18. The method of claim 11, wherein said kite comprises one or more structural members configured to form a framework for said kite, and sail material wrapped around at least portions of said framework, and wherein said step of securing further comprises securing said camera to said sail material.

19. The method of claim 11, further comprising the step of coupling a timer to said camera for actuating said camera to take at least one picture after at least one predetermined lapse of time.

20. The method of claim 11, further comprising the step of coupling an aerial communication device to said camera, said aerial communication device being responsive to signals transmitted from a ground communication device for actuating said camera to take a photograph.

21. The method of claim 11, further comprising an aerial communication device coupled to said camera, said aerial communication device being adapted for receiving images generated by said camera and transmitting said images to a ground communication device.

22. A kit for facilitating aerial photography, the kit comprising:
sail material capable of being configured as a kite;
a camera configured for taking aerial photographs while coupled to said kite; and
means capable of coupling said camera to said kite.

23. The kit of claim 22, wherein said means comprise at least one of adhesive, straps, hook-and-loop material, clips, a pouch on a sail, magnets, string, a Picavet, a pendulum, and wire.

24. The kit of claim 22, wherein said means is capable of securing said camera in a substantially fixed position relative to said kite.

25. The kit of claim 22, wherein said means is capable of securing said camera to said sail material.

26. The kit of claim 22, further comprising one or more structural members capable of being connected together to form a framework across which framework said sail material is extended.

27. The kit of claim 22, further comprising one or more structural members capable of being connected together to form a framework across which framework said sail material is extended, said means being capable of securing said camera to said one or more structural members in a substantially fixed position relative to said kite.

28. The kit of claim 22, wherein said means comprises at least one string capable of suspending said camera from said kite.

29. The kit of claim 22, wherein said kite comprises at least one of a flat kite, a box kite, a delta box kite, a cellular kite, a cylindrical kite, a bowed kite, a dihedral kite, a sled kite, a cellular kite, and a parafoil kite.

30. The kit of claim 22, further comprising a timer capable of being coupled to said camera for actuating said camera to take at least one picture after at least one predetermined lapse of time.

31. The kit of claim 22, further comprising an aerial communication device capable of being coupled to said camera, said aerial communication device being responsive to signals transmitted from a ground communication device for actuating said camera to take a photograph.

32. The kit of claim 22, further comprising an aerial communication device capable of being coupled to said camera, said aerial communication device being adapted for receiving images generated by said camera and transmitting said images to a ground communication device.
